(19) United States
(12) Patent Application Publication
(10) Pub. No.: US 2005/0254851 A1
(43) Pub. Date: Nov. 17, 2005

(54) Ozone purification unit and wet-type electrophotographic image forming apparatus having the same

(75) Inventors: Myoung-chan Kim, Seoul (KR); Sung-dae Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/062,696

(22) Filed: Feb. 23, 2005

(30) Foreign Application Priority Data
May 11, 2004 (KR) 2004-32938

(51) Int. Cl. G03G 21/20

(52) U.S. Cl. 399/93

(57) ABSTRACT

An ozone purification unit of an electrographic image forming apparatus oxidizes and removes ozone using a catalyst filter. The ozone is carried by a carrier vapor generated in the wet-type electrophotographic image forming apparatus. The ozone purification unit of the wet-type electrophotographic image forming apparatus has a holder member that forms inner and outer paths in a sealing member to partition an engine part of the image forming apparatus and to support the catalyst filter. A fan is disposed at an exit of the holder member to draw in the carrier vapor into the catalyst filter. A heater is disposed at an entrance of the holder member and around the catalyst filter to heat the drawn-in carrier vapor and to prevent the carrier vapor from being deposited on the catalyst filter. A cooling device cools the carrier vapor from which the ozone is removed after passing through the catalyst filter and the heater.

### CROSS-REFERENCE TO RELATED APPLICATIONS

This application claims the benefit under 35 U.S.C. § 119(a) of Korean Patent Application No. 2004-32938, filed May 11, 2004, in the Korean Intellectual Property Office, the entire disclosure of which is hereby incorporated by reference.

### BACKGROUND OF THE INVENTION

1. Field of the Invention

The present invention relates to a wet-type electrophotographic image forming apparatus. More particularly, the present invention relates to an ozone purification unit for removing ozone (O₃) contained in a chemical compound, and a wet-type electrophotograhic image forming apparatus having the same.

2. Description of the Related Art

Generally, a wet-type electrophotographic image forming apparatus, such as a printer or a multi-function office machine, scans a laser beam onto a photoconductive medium, such as a photoconductive belt or drum, to form an electrostatic latent image. A visible image formed by attaching a developer onto the electrostatic latent image is transferred, thereby implementing a desired image.

FIG. 1 illustrates an example of a wet-type electrophotographic image forming apparatus. The wet-type electrophotographic image forming apparatus has a plurality of electrifying units 131, 132, 133 and 134 for forming an electrostatic latent image respectively on a plurality of photoconductive drums 121, 122, 123 and 124 provided in a main body 110. A plurality of laser scanning units 141, 142, 143 and 144, and a plurality of developing units 151, 152, 153 and 154 apply a developer on the electrostatic latent imageto develop the image. A plurality of first transfer rollers 171, 172, 173 and 174 and a second transfer roller 180 transfer the developed image onto a printing medium P. A fusing unit 190 fuses the image transferred on the printing medium P by heat and pressure. An oxidant unit 195 purifies a carrier vapor generated during the printing process.

In using the above-described wet-type electrophotographic image forming apparatus 100, the carrier vapor generated in the developing units 151, 152, 153 and 154 and the fusing unit 190 is mixed with ozone (O₃) generated by electric discharge of the electrifying units 131, 132, 133 and 134.

In the conventional wet-type electrophotographic image forming apparatus 100, the oxidant unit 195 purifies the carrier vapor. However, in order to totally purify the carrier vapor generated in the wet-type electrophotographic image forming apparatus 100, a mass of the oxidant units needs to be provided, which is expensive.

More specifically, although a carrier vapor C in a sealing member 198 of the conventional wet-type electrophotographic image forming apparatus 100 is in very low concentration, the carrier vapor C containing ozone is drawn into the oxidant unit 195 in a direction indicated by arrow A of FIG. 1 through a suction path 196, such that the ozone included in the carrier vapor C is removed.

The drawn-in carrier vapor C containing the ozone is mixed with a carrier vapor B of high concentration that is generated in the fusing unit 190.

Since the oxidant reacts at a high temperature, ozone is thermally oxidized in the oxidant unit 195.

Therefore, the oxidant unit 195 has to process a relatively large amount of the carrier vapor B+C compared to when processing only the high-concentration carrier vapor B.

Thus, to react the oxidant in the oxidant unit 195 with the large amount of carrier vapor B+C, the oxidant needs to be applied over a wide area.

As a result, a large quantity of the oxidant is required, thereby increasing manufacturing costs.

There is a well-known general method for removing ozone, which uses a catalyst capable of oxidizing ozone at a normal temperature. However, the carrier vapor is condensed and deposited on a surface of the catalyst in the wet-type electrophotographic image forming apparatus 100, and this deteriorates performance and lifespan of the catalyst. Therefore, the general method is not suitable for the wet-type electrophotographic image forming apparatus 100.

### SUMMARY OF THE INVENTION

Accordingly, an aspect of the present invention is to provide an ozone (O₃) purification unit for collecting ozone included in a carrier vapor generated in a wet-type electrophotographic image forming apparatus by a catalyst filter and removing the ozone in an effective and economical way, and a wet-type electrophotographic image forming apparatus having the same.

Another aspect of the present invention is to provide a wet-type electrophotographic image forming apparatus for economically removing a carrier vapor generated during an image forming process using a small amount of oxidant.

Still another aspect of the present invention is to provide an ozone purification unitdisposed in a system, such as a device that generates a compound gas containing ozone, to collect the ozone by a catalyst filter, thereby removing the ozone effectively and economically.

An ozone purification unit is disposed in a system that generates a compound gas comprising ozone to oxidize and remove the ozone using a catalyst filter. The ozone purification unit has a holder member for supporting the catalyst filter. A guide fan draws in and guides the compound gas to help the compound gas pass through the catalyst filter. A heating device heats the compound gas to prevent deposition of the compound gas onto the catalyst filter.

The heating device has a plurality of unit heaters mounted on a front of the catalyst filter.

The plurality of unit filters are structured in a web or a honeycomb form.

The heating device further includes a band heater surrounding the catalyst filter.

The ozone purification unit further includes an adiabatic member surrounding the band heater.

The ozone purification unit further includes a cooling device for cooling heat generated from the compound gas that passes through the catalyst filter.

A wet-type electrophotographic image forming apparatus includes an electrifying unit for forming an electrostatic latent image on a photoconductive medium. A developing unit applies a developer to the photoconductive medium. A transfer, unit transfers the developer developed on the photoconductive medium to a paper. A fusing unit fixes the developer onto the paper. An oxidant unit oxidizes a carrier vapor generated in the fusing unit. An ozone purification unit oxidizes and removes ozone generated in the electrifying unit using a catalyst filter.

The ozone purification unit includes a holder member for supporting the catalyst filter. A guide fan draws in and guides the compound gas to help the compound gas pass through the catalyst filter. A heating device heats the compound gas to prevent deposition of the compound gas onto the catalyst filter.

The heating device includes a plurality of unit heaters mounted on a front of the catalyst filter.

The plurality of unit filters are structured in a web or a honeycomb form.

The heating device further includes a band heater surrounding the catalyst filter.

The wet-type electrophotographic image forming apparatus further includes an adiabatic member surrounding the band heater.

The wet-type electrophotographic image forming apparatus further includes a cooling device for cooling heat generated from the compound gas that passed through the catalyst filter.

Other objects, advantages and salient features of the invention will become apparent from the following detailed description, which, taken in conjunction with the annexed. drawings, discloses preferred embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a schematic view of a conventional wet-type electrophotographic image forming apparatus;

FIG. 2 is a schematic view of a wet-type electrophotographic image forming apparatus according to an embodiment of the present invention;

FIG. 3 is a schematic view of an ozone purification unit of FIG. 2;

FIGS. 4A and 4B are perspective views of a unit heater of the ozone purification unit of FIG. 3;

FIG. 5 is a perspective view of the mutual operation of a catalyst filter, a band heater and an adiabatic member of FIG. 3; and

FIG. 6 is a perspective view of a cooling member of FIG. 3.

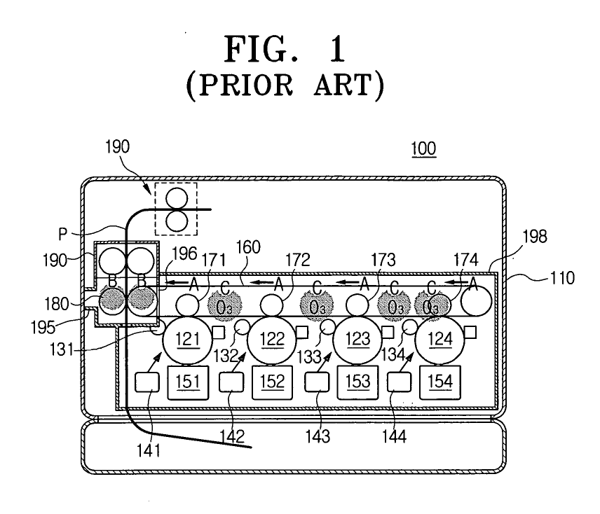

Throughout the drawings, like reference numerals will be understood to refer to like parts, components and structures.

### DETAILED DESCRIPTION OF EXEMPLARY EMBODIMENTS

Hereinafter, an oxidant unit and a wet-type electrophotographic image forming apparatus having the same according to exemplary embodiments of the present invention will be described in detail with reference to the accompanying drawing figures.

The matters defined in the description, such as a detailed construction and elements thereof, are provided to assist in a comprehensive understanding of the invention. Thus, it is apparent that the present invention may be carried out without those defined matters. Also, well-known elements and constructions are not described in detail for conciseness and clarity.

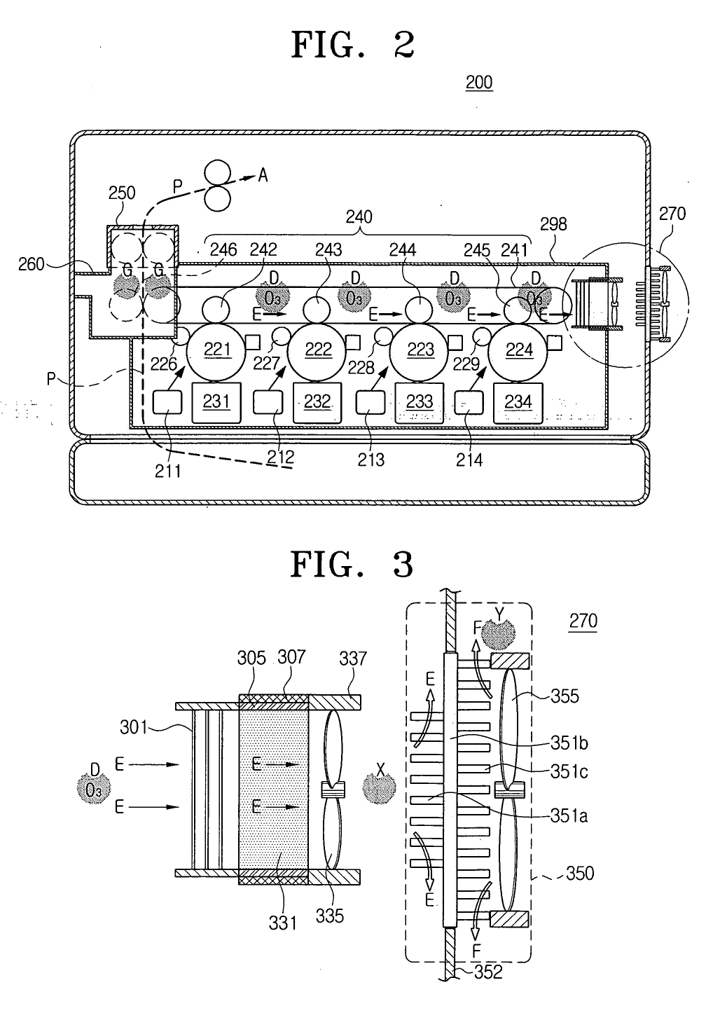

FIG. 2 schematically illustrates a wet-type electrophotographic image forming apparatus according to an exemplary embodiment of the present invention.

Referring to FIG. 2, the wet-type electrophotographic image forming apparatus 200 includes a plurality of laser scanning units 211, 212, 213 and 214; a plurality of photoconductive drums 221, 222, 223 and 224; a plurality of electrifying units 226, 227, 228 and 229; a plurality of developing units 231, 232, 233 and 234; a transfer unit 240; a fusing unit 250; an oxidant unit 260; and an ozone purification unit 270.

The plurality of laser scanning units 211, 212, 213 and 214 scan a laser beam onto surfaces of the plurality of photoconductive drums 221, 222, 223 and 224 that are electrified with a certain electric potential by the electrifying units 226, 227, 228 and 229.

Surfaces of the photoconductive drums 221, 222, 223 and 224 are coated with a photoconductive sensitization layer. A difference in the electric potentials is caused on the surfaces of the photoconductive drums 221, 222, 223 and 224 scanned with the laser beam, thereby forming an electrostatic latent image.

The developing units 231, 232, 233 and 234 supply the developer respectively to the photoconductive drums 221, 222, 223 and 224. The developing units 231, 232, 233 and 234 respectively store developers of different colors, such as yellow, magenta, cyan and black. Upon formation of the electrostatic latent image on the photoconductive drums 221, 222, 223 and 224, the developing units 231, 232, 233 and 234 transfer the respective color developers onto the photoconductive drums 221, 222, 223 and 224.

Accordingly, visible images are formed by the developers on the surfaces of the respective photoconductive drums 221, 222, 223 and 224. The developers consist of a toner for developing the electrostatic latent image and a liquid carrier for facilitating movement of the toner.

The transfer unit 240 transfers the visible images formed on the photoconductive drums 221, 222, 223 and 224 onto a paper. The transfer unit 240 comprises a transfer belt 241, first transfer rollers 242, 243, 244 and 245, and a second transfer roller 246. As shown in FIG. 2, the transfer belt 241 receives the visible images while running in contact with the surfaces of the photoconductive drums 221, 222, 223 and 224.

The respective first transfer rollers 242, 243, 244 and 245 are mounted to correspond to the photoconductive drums 221, 222, 223 and 224 to transfer the visible images formed on the photoconductive drums 221, 222, 223 and 224 onto the transfer belt 241. The developers of different colors, such as yellow, magenta, cyan and black, are overlapped with one another on the transfer belt 241, thereby forming a color image.

The second transfer roller 246 transfers the color image formed on the transfer belt 241 onto a paper.

The fusing unit 250 applies heat and pressure to the paper to fix the color image formed on the transfer belt 241 onto the paper. During the heat and pressure application period, the liquid carrier of developer components is vaporized, thereby generating a carrier vapor G

The oxidant unit 260 purifies the carrier vapor G generated in the fusing unit 250.

The ozone purification unit 270 thermally oxidizes ozone (O₃) generated by electric discharge from the electrifying units 226, 227, 228 and 229.

The high temperature carrier vapor G generated in the fusing unit 250 is purified by the oxidant unit 260, and ozone included in the low-concentration carrier vapor D generated in the developing units 231, 232, 233 and 234 is removed by the ozone purification unit 270. Accordingly, a very small amount of oxidant is required.

FIG. 3 is a schematic view of the ozone purification unit 270 of FIG. 2. The ozone purification unit 270 includes a holder member 337, a guide fan 335, heating devices 301, 305 and 307, and a cooling device 350.

The holder member 337 forms inner and outer paths in a sealing member 298 (FIG. 2), thereby partitioning an engine part of the wet-type electrophotographic image forming apparatus 200 (FIG. 2), and supports the guide fan 335 and the heating devices 301, 305 and 307.

The guide fan 335 draws in and induces the low-concentration carrier vapor D containing the ozone toward a catalyst filter 331.

The heating device 305 includes a plurality of unit heaters 301 disposed in front of the catalyst filter 331, a band heater 305 enclosing the catalyst filter 331, and an adiabatic member 307 enclosing the band heater 305. With this arrangement, the heating device 305 prevents deterioration of performance and lifespan of the catalyst filter 331 caused by the low-concentration carrier vapor D drawn through the catalyst filter 331.

The cooling device 350 is disposed behind the guide fan 335 to remove heat inside the wet-type electrophotographic image forming apparatus 200 (FIG. 2) for the normal operation of the whole apparatus.

The cooling device 350 includes a cooling plate 351b to remove heat from the low-concentration carrier vapor D that is heated while passing through the unit heater 301 and the band heater 305. The cooling device 350 also includes a front cooling fin 351a and a rear cooling fin 351c projected from a front surface and a back surface of the cooling plate 351b, respectively.

A rear cooling fan 355 is further provided externally of a casing 352 of the wet-type electrophotographic image forming apparatus 200 (FIG. 2) to enhance cooling efficiency.

With the above structure, the ozone included in the unit heater 301 flows in a direction indicated by arrow E, thereby being primarily heated by the unit heater 301.

The ozone in the heated low-concentration carrier vapor D is oxidized while passing through the catalyst filter 331. The band heater 305 reheats the low-concentration carrier vapor D surrounding the catalyst filter 331 to prevent a liquid carrier, which is generated from the cooling of low-concentration carrier vapor D, from attaching to the catalyst filter 331 while the ozone is oxidized.

An ozone-removed carrier vapor X drains to the outside of the sealing member 298 (FIG. 2) in the direction indicated by arrow E by the guide fan 335 mounted in the holder member 337.

The heat of the ozone-removed carrier vapor X that drains out of the sealing member 298 (FIG. 2) collides with the cooling fin 351a projected on the front surface of the cooling plate 351b and is discharged outwardly therefrom.

Some of the heat in the ozone-removed carrier vapor X is transmitted through the cooling plate 351b, and the transmitted heat is drained out of the wet-type electrophotographic image forming apparatus 200 (FIG. 2) through a rear side of the cooling plate 351b and the rear cooling fin 351c.

The rear cooling fan 355 continuously or intermittently drives for quick removal of the heat, and draws in external cool air Y (FIG. 3) in a direction indicated by arrow F, such that the cool air Y collides with the rear side of the cooling plate 351b and the rear cooling fin 351c.

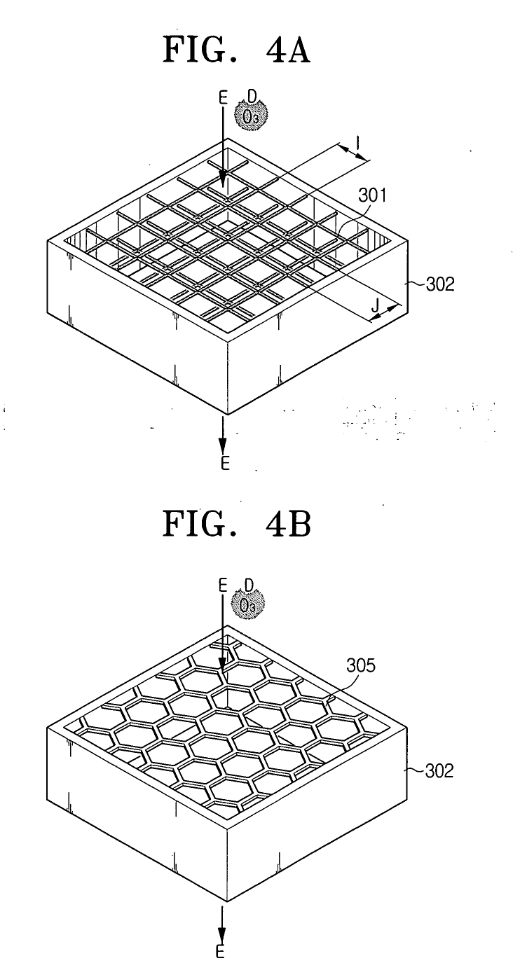

FIGS. 4A and 4B are perspective views showing the unit heater of the oxidant unit of FIG. 3. Referring to FIG. 4A, the unit heater 301 is disposed within a supporter wall 302 surrounding the unit heater 301 and supplying power to the unit heater 301.

The unit heater 301 applies heat to the low-concentration carrier vapor D to prevent the liquid carrier from being attached on the catalyst filter 331 when the liquid carrier is generated from the cooling of the low-concentration carrier vapor D.

A length interval I and a width interval J of the unit heater 301 are narrowly formed for a dense texture of the unit heater 301 such that a lot of heat is transmitted to the low-concentration carrier vapor D in a short time.

As shown in FIG. 4B, the unit heater 301 may be formed in any suitable manner, such as the shown honeycomb pattern. In addition to the web and the honeycomb patterns of FIGS. 4A and 4B, the unit heater 301 may have other various forms for transmission of heat to the low-concentration carrier vapor D.

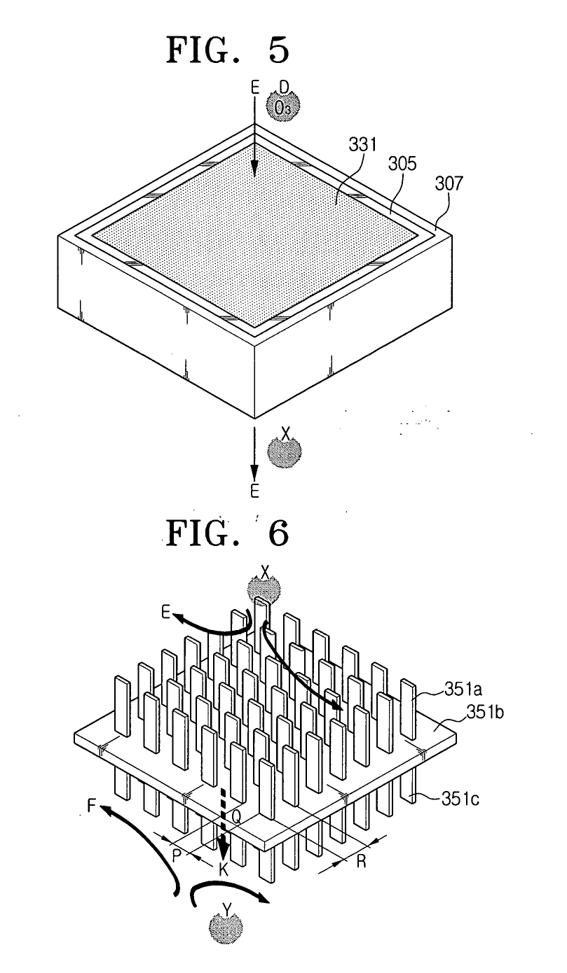

FIG. 5 is a perspective view showing the relationship in operation among the catalyst filter 331, the band heater 305 and the adiabatic member 307. Referring to FIG. 5, the band heater 305 encloses the catalyst filter 331 and reheats the low-concentration carrier vapor D to prevent the low-concentration carrier vapor D heated by the unit heater 301 (FIG. 4A) from being condensed by reaction with the catalyst filter 331.

The band heater 305 may apply the heat to the catalyst filter 331 constantly or intermittently according to an amount of the low-concentration carrier vapor D.

The adiabatic member 307 encloses the band heater 305 to prevent heat leakage from the band heater 305.

For adiabatic efficiency, a fibroid material formed of a ceramic fiber is preferably used for the adiabatic member 307.

With this arrangement, the low-concentration carrier vapor D becomes the ozone-removed carrier vapor X after reacting with the catalyst filter 331, and is discharged out of the catalyst filter 331 in the direction indicated by arrow E.

FIG. 6 is a perspective view showing the cooling device of FIG. 3. Referring to FIG. 6, the cooling plate 351b removes heat from the ozone-removed carrier vapor X and transmits the heat externally of the wet-type electrophotographic image forming apparatus 200 (FIG. 2).

The front cooling fin 351a and the rear cooling fin 351c are projected from the cooling plate 351b to increase a cooling surface area. For a more dense texture, a length interval P and a width interval R are formed preferably narrowly.

The number of the rear cooling fins 351c is greater than that of the front cooling fins 351a so that the cool air Y exiting the wet-type electrophotographic image forming apparatus 200 (FIG. 2) widely contacts the rear cooling fin 351c.

The cooling plate 351b, the front cooling fin 351a and the rear cooling fin 351c may be formed of metal, such as copper and aluminum for higher thermal conductivity.

With the above structure, a heat Q included in the ozone-removed carrier vapor X is transmitted in the direction indicated by arrow E and removed upon colliding with the front cooling fin 351a and the cooling plate 351b. Also, some of the heat Q is passed through the cooling plate 351b and removed by the cool air Y colliding with the rear cooling fin 351c and the rear side of the cooling plate 351b. Accordingly, the inside of the wet-type electrophotographic image forming apparatus 200 (FIG. 2) is maintained at a proper temperature, thereby enabling the normal operation of the wet-type electrophotographic image forming apparatus 200 (FIG. 2).

As can be appreciated from the above description of the ozone purification unit 270 and the wet-type electrophotographic image forming apparatus 200 having the same, according to exemplary embodiments of the present invention, an inner temperature of the apparatus does not increase, and ozone is thermally oxidized by a dedicated ozone purification unit 270. Therefore, use of an oxidant may be reduced, thereby saving expenses.

Further, even in a system, such as a device that generates a compound gas, performance and lifespan of the catalyst are not deteriorated.

While the invention has been shown and described with reference to certain embodiments thereof, it will be understood by those skilled in the art that various changes in form and details may be made therein without departing from the spirit and scope of the invention as defined by the appended claims.

1. An ozone purification unit to oxidize and remove ozone, comprising:
a catalyst filter;
a holder member to support the catalyst filter;
a guide fan to draw in and guide the compound gas to help the compound gas pass through the catalyst filter; and
a heating device to heat the compound gas to prevent deposition of the compound gas onto the catalyst filter.

2. The ozone purification unit of claim 1, wherein
a plurality of unit heaters are mounted in front of the catalyst filter.

3. The ozone purification unit of claim 2, wherein
the plurality of unit filters are structured in a web form.

4. The ozone purification unit of claim 2, wherein
the plurality of unit filters are structured in a honeycomb form.

5. The ozone purification unit of claim 2, wherein
a band heater surrounds the catalyst filter.

6. The ozone purification unit of claim 5, wherein
an adiabatic member surrounds the band heater.

7. The ozone purification unit of claim 1, wherein
a cooling device cools heat generated from the compound gas that passes through the catalyst filter.

8. A wet-type electrophotographic image forming apparatus, comprising:
an electrifying unit to form an electrostatic latent image on a photoconductive medium;
a developing unit to apply a developer to the photoconductive medium;
a transfer unit to transfer the developer developed on the photoconductive medium to a paper;
a fusing unit to fix the developer onto the paper;
an oxidant unit to oxidize a carrier vapor generated in the fusing unit; and
an ozone purification unit having a catalyst filer disposed therein to oxidize and remove ozone generated in the electrifying unit.

9. The wet-type electrophotographic image forming apparatus of claim 8, wherein
a holder member supports the catalyst filter;
a guide fan draws in and guides the compound gas to facilitate passing the compound gas through the catalyst filter; and
a heating device to heat the compound gas to substantially prevent deposition of the compound gas onto the catalyst filter.

10. The wet-type electrophotographic image forming apparatus of claim 9, wherein
a plurality of unit heaters are mounted on a front of the catalyst filter.

11. The wet-type electrophotographic image forming apparatus of claim 10, wherein
the plurality of unit filters are structured in a web form.

12. The wet-type electrophotographic image forming apparatus of claim 10, wherein
the plurality of unit filters are structured in a honeycomb form.

13. The wet-type electrophotographic image forming apparatus of claim 10, wherein
a band heater surrounds the catalyst filter.

14. The wet-type electrophotographic image forming apparatus of claim 13, wherein
an adiabatic member surrounds the band heater.

15. The wet-type electrophotographic image forming apparatus of claim 8, wherein
a cooling device cools heat generated from the compound gas that passes through the catalyst filter.

16. A method of removing ozone from an electrophotographic image forming apparatus generated during an image forming process, comprising the steps of
purifying a high temperature carrier vapor generated when heat and pressure is applied to a paper to fix the image thereon with an oxidant unit disposed in the electrographic image forming apparatus;
drawing an ozone vapor to an ozone purification unit disposed in the electrographic image forming apparatus with a guide fan;
heating the ozone vapor;
passing the heated ozone vapor through a catalyst filter in the ozone purification unit to remove ozone from the ozone vapor;
reheating the ozone vapor as the ozone is being removed therefrom to prevent liquid from forming during the ozone removal step and depositing on the catalyst filter;
removing heat from the reheated ozone-removed vapor by passing the reheated ozone-removed vaport through a cooling unit; and
discharging the removed heat from the electrographic image forming apparatus.

17. A method of removing ozone from an electrophotographic image forming apparatus generated during an image forming process according to claim 16, further comprising
drawing the reheated ozone-removed vapor through a cooling plate having cooling fins extending outwardly therefrom from front and rear surfaces thereof to increase the cooling surface area of the cooling unit.

18. A method of removing ozone from an electrophotographic image forming apparatus generated during an image forming process according to claim 17, further comprising
forming the cooling plate and the cooling fins of metal to increase the thermal conductivity of the cooling unit.

19. A method of removing ozone from an electrophotographic image forming apparatus generated during an image forming process according to claim 16, further comprising
enclosing the catalyst filter with an adiabatic member to prevent heat leakage from the catalyst filter during the reheating step.

20. A method of removing ozone from an electrophotographic image forming apparatus generated during an image forming process according to claim 16, further comprising
forming more fins on the rear surface of the cooling plate than on the front surface to facilitate removing heat from the reheated ozone-removed vapor.
